(19) United States
(12) Patent Application Publication
(10) Pub. No.: US 2006/0045544 A1
(43) Pub. Date: Mar. 2, 2006

(54) Method for requesting service by use of two-way real-time communication with service center server

(75) Inventors: Duk-yong Kim, Suwon-si (KR); Sung-won Chae, Gwangmyeong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/211,575

(22) Filed: Aug. 26, 2005

(30) Foreign Application Priority Data
Aug. 27, 2004 (KR) 10-2004-0068068

(51) Int. Cl. G03G 15/00

(52) U.S. Cl. 399/8

(57) ABSTRACT

A system and method is provided for requesting service for an image formation apparatus using two-way real-time communication with a service center server. The method for requesting the service from the service center server providing services relating to an image formation apparatus by using a terminal apparatus connected to the image information apparatus includes the steps of inputting a connection command for connecting the terminal apparatus and the service center server, connecting the terminal apparatus and the service center server to perform two-way real-time communication, and requesting the service from the service center server through the terminal apparatus. Accordingly, the user can request and receive the service for the image formation apparatus by the use of the two-way real-time communication with the operator of the service center server.

### CROSS-REFERENCE TO RELATED APPLICATIONS

This application claims the benefit under 35 U.S.C. §119(a) of Korean Patent Application No. 10-2004-0068068, filed in the Korean Intellectual Property Office on Aug. 27, 2004, the entire disclosure of which is incorporated herein by reference.

### BACKGROUND OF THE INVENTION

1. Field of the Invention

The present invention relates to a method for requesting a service. More particularly, the present invention relates to a system and method for requesting a service which allows a user to request a service from a service center server providing services relating to an image formation apparatus when the user has an inquiry or an error occurs in using the image formation apparatus.

2. Description of the Related Art

A conventional image formation apparatus outputs generated image data or externally-input image data to printing paper. Exemplary image formation apparatuses include a copier, printer, scanner, and fax device, which can be integrated as a composite image formation apparatus (such as a multi-function peripheral (MFP)).

It is important to manufacture such an image formation apparatus that can be easily used, and having excellent durability. However, in using the image formation apparatus, a user may have an inquiry about the image formation apparatus or an error may occur during operation.

A manufacturing company is responsible for providing high quality service to the users of these products any time the users request such service, such as when the users have inquiries about the product or requests to correct product errors.

Generally, in these situations a user uses a telephone and/or the Internet as a means for sending a request for a service to a service center.

When the user uses the telephone, the user can get a prompt reply from the service center. However, the user must first personally find a telephone number of the service center. In addition, since the user and the service center can only perform voice inquiries and replies via the telephone, the user is not provided with visual information about the reply to the inquiry.

The user may choose the Internet, and in this case, the user can get general visual information regarding the image formation apparatus on a homepage of the service center. However, the user usually gets limited information from the homepage of the service center. If the user cannot solve the problem by referring to the homepage of the service center, the user must individually make an inquiry on the homepage of the service center. Normally, the reply to the inquiry is not directly provided by the service center, but is transmitted to the user through an E-mail afterwards. As a result, the user cannot get a prompt reply to the inquiry.

Accordingly, a need exists for a system and method for efficiently and effectively requesting a service from a service center providing services relating to an image formation apparatus.

### SUMMARY OF THE INVENTION

Accordingly, it is a primary object of the present invention to substantially solve the above and other problems, and provide a method for requesting a service by the use of two-way real-time communication with a service center server which enables a user to easily and directly receive a service when the user has an inquiry or an error occurs in using an image formation apparatus.

In order to achieve the above-described and other objects of the present invention, a system and method is provided for requesting a service from a service center server providing services relating to an image formation apparatus by using a terminal apparatus connected to the image information apparatus. The method comprises the steps of (a) inputting a connection command for connecting the terminal apparatus and the service center server, (b) connecting the terminal apparatus and the service center server to perform two-way real-time communication if the connection command is input, and (c), requesting service from the service center server through the terminal apparatus.

Preferably, in step (c), the service request is made through at least one of a chat and a visual chat between a user of the terminal apparatus and an operator of the service center server.

Preferably, in step (c), the service request includes at least one of an inquiry about specifications of the image formation apparatus, an inquiry about usage of the image formation apparatus, an inquiry about handling of an operational error of the image formation apparatus, a repair request for the image formation apparatus, an inquiry about supplies for the image formation apparatus, a purchase request for supplies for the image formation apparatus, an inquiry about driver updates of the image formation apparatus, an inquiry about firmware updates of the image formation apparatus, a transmission request for a new version driver of the image formation apparatus, and a transmission request for a new version firmware of the image formation apparatus.

Preferably, in step (c), when the service request is any one of the inquiries about handling of operational errors of the image formation apparatus and repair requests for the image formation apparatus, the terminal apparatus transmits an operation recording file generated in the image formation apparatus to the service center server.

Preferably, a method for requesting service further comprises a step (d) for receiving, through the terminal apparatus, the service provided by the operator of the service center server in response to the service request.

Preferably, in step (b), the terminal apparatus and the service center server are connected to perform the two-way communication by using any one of a driver of the image formation apparatus, a chat program, and a chat program included in the driver of the image formation apparatus, that can each be installed on the terminal apparatus.

Preferably, in step (a), the connection command is input by using a user interface screen provided by any one of the driver of the image formation apparatus, the chat program, and the chat program included in the driver of the image formation apparatus.

Preferably, in step (a), the connection command is input by using a sub-menu screen relating to the connection between the terminal apparatus and the service center server and which is displayed on the user interface screen.

Preferably, in step (b), after the terminal apparatus and the service center server are connected to perform the two-way real-time communication, the terminal apparatus is verified by an admission procedure of the service center server by using an identified number of the image formation apparatus.

Preferably, the identified number is comprised of at least one of an ID, a serial number, and a model name of the image formation apparatus.

Preferably, in step (b), after the terminal apparatus and the service center server are connected to perform the two-way communication, the terminal apparatus is verified by an admission procedure of the service center server by using at least one of an ID and password of the user that are registered in the service center server.

Preferably, step (a) comprises the sub-steps of displaying a list of service center servers when a plurality of service center servers are connectable to the terminal apparatus, and selecting, through the terminal apparatus, any one of the plurality of service center servers displayed on the list to be connected to the terminal apparatus.

Preferably, the list of the plurality of service center servers is updated at a predetermined time interval.

Preferably, the plurality of service center servers may exist in different countries.

### BRIEF DESCRIPTION OF THE DRAWINGS

The above aspects and features of the present invention will become more apparent by describing certain embodiments of the present invention with reference to the accompanying drawings, in which:

FIG. 1 is a schematic block diagram illustrating a system for requesting a service to which an embodiment of the present invention can be applied;

FIG. 2 is a detailed block diagram illustrating an MFP and a PC of FIG. 1 in greater detail in accordance with an embodiment of the present invention;

FIG. 3 is a flowchart illustrating steps of a method for requesting a service by the use of two-way real-time communication with a service center server in accordance with an embodiment of the present invention;

FIG. 4A is an exemplary diagram illustrating a user interface screen provided by an MFP driver in accordance with an embodiment of the present invention;

FIG. 4B is an exemplary diagram illustrating a user interface screen showing a list of service center servers connectable to the PC in accordance with an embodiment of the present invention;

FIG. 4C is an exemplary diagram illustrating a user interface screen provided while the PC and the service center server are connected to each other in accordance with an embodiment of the present invention; and

FIG. 4D is an exemplary diagram illustrating a user interface screen showing chat contents between a user of the PC and an operator of the service center server in accordance with an embodiment of the present invention.

Throughout the drawings, like reference numerals will be understood to refer to like parts, components and structures.

### DETAILED DESCRIPTION OF THE EXEMPLARY EMBODIMENTS

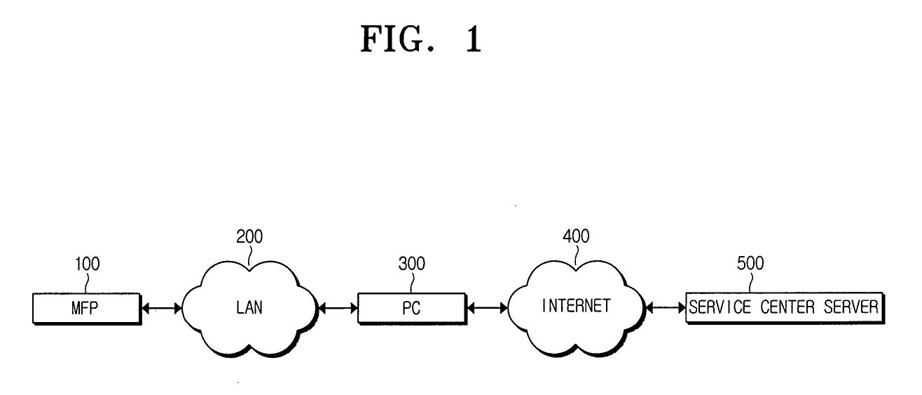

FIG. 1 is a schematic block diagram illustrating a system for requesting a service to which an embodiment of the present invention can be applied. Referring to FIG. 1, the system for requesting service is comprised of an MFP 100, a PC 300, and a service center server 500. The PC 300 is connected to each element through communication networks 200 and 400, respectively. Specifically, the PC 300 and the MFP 100 are connected through a local area network (LAN) 200 to perform mutual communication, and the PC 300 and the service center server 500 are connected through an internet 400 to perform mutual communication.

The MFP 100 is comprised of an image formation apparatus formed by integrating functions of a copier, printer, fax, scanner, and other such devices. The MFP 100 creates and stores a log file that is an operation recording file, and transmits the stored log file to the PC 300.

The service center server 500 is comprised of a server of a service center for providing services relating to the MFP 100. Generally, the service center server 500 can be comprised of a server prepared at a manufacturing company or an A/S center of the MFP 100. A plurality of service center servers may exist for one MFP 100. However, to simplify the following description, FIG. 1 shows only one service center server 500.

The PC 300 is comprised of a user terminal apparatus for transmitting printing data to the MFP 100 through the LAN 200 for printing. If the user has an inquiry about the MFP 100 or an error occurs, the user can request a desired service inquiry to the service center server 500 by using the PC 300.

The PC 300 and the service center server 500 can be connected through the internet 400 to perform two-way real-time communication. Therefore, the user of the PC 300 and the operator of the service center server 500 can chat or visual-chat with each other regarding the inquiry.

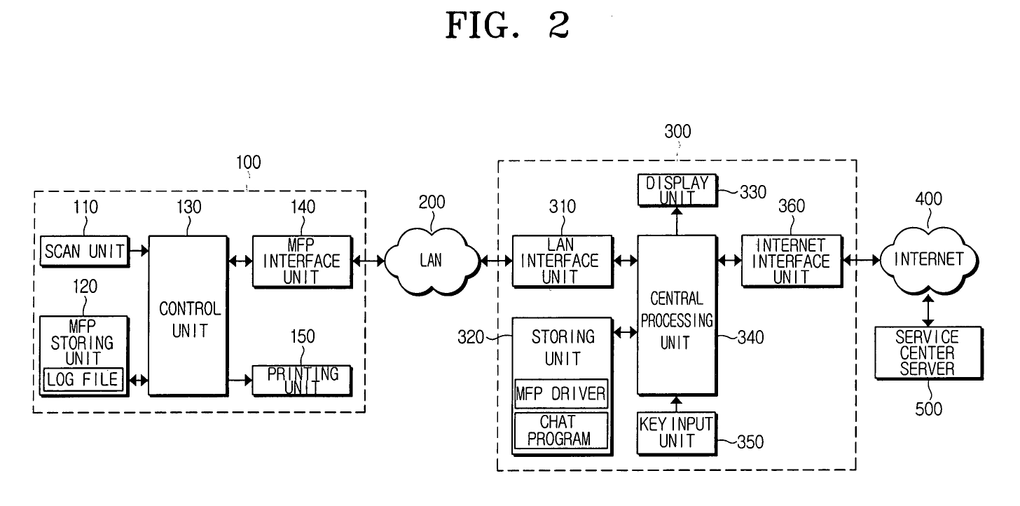

The MFP 100 and the PC 300 will now be described in greater detail with reference to FIG. 2. FIG. 2 is a detailed block diagram illustrating the MFP 100 and the PC 300 of FIG. 1 in accordance with an embodiment of the present invention.

First, the MFP 100 will be described in greater detail. The MFP 100 is comprised of a scan unit 110, an MFP storing unit 120, a control unit 130, an MFP interface unit 140, and a printing unit 150.

The scan unit 110 generates scan data by scanning a scan object paper. The MFP storing unit 120 is comprised of a recording medium for storing the scan data generated by the scan unit 110 and printing data which the MFP interface unit 140 receives from the PC 300. In addition, the MFP storing unit 120 stores a log file generated by the control unit 130.

The MFP interface unit 140 performs data communication with the PC 300 through the LAN 200. The printing unit 150 prints the scan data or printing data stored in the MFP storing unit 120 on printing paper under the control of the control unit 130.

The control unit 130 controls the scanning of the scan unit 110, the communication of the MFP interface unit 140, and the printing of the printing unit 150. Moreover, the control unit 130 creates the log file and stores it in the MFP storing unit 120. The control unit 130 can transmit the log file stored in the MFP storing unit 120 to the PC 300 through the MFP interface unit 140.

The log file is comprised of the operation recording file for recording the operational contents of the MFP 100. Here, the log file records the use setup contents of the MFP 100, and can also record the use environment contents of the MFP 100. In case an error occurs in the MFP 100, the log file may also record an error occurrence and cause.

The PC 300 will now be described in greater detail. The PC 300 is comprised of a LAN interface unit 310, a storing unit 320, a display unit 330, a central processing unit 340, a key input unit 350, and an internet interface unit 360.

The LAN interface unit 310 performs data communication with the MFP 100 through the LAN 200. The internet interface unit 360 performs data communication with the service center server 500 through the internet 400.

The storing unit 320 is comprised of a recording medium for storing data and programs used in the PC 300. Generally, the storing unit 320 may be comprised of a hard disk drive, but is not limited thereto. The storing unit 320 also stores an MFP driver used for setup and driving control of the MFP 100, and also stores a chat program. However, both are not required to be embodied as individual programs. That is, the MFP driver can be embodied to include the chat program. Hereinafter, in the following exemplary embodiment it is presumed that the MFP driver includes the chat program.

The display unit 330 is comprised of a display device for displaying a user interface screen provided by the MFP driver. Generally, the display unit 330 may be comprised of a monitor, but is not limited thereto. The key input unit 350 is comprised of a user interface device for receiving an operational command from the user, and transmitting the received command to the central processing unit 340. Normally, the key input unit 350 is comprised of a keyboard and a mouse, but is not limited thereto.

The central processing unit 340 executes the MFP driver and the chat program stored in the storing unit 320, controls the display of the display unit 330, and controls the communication between the LAN interface unit 310 and the internet interface unit 360.

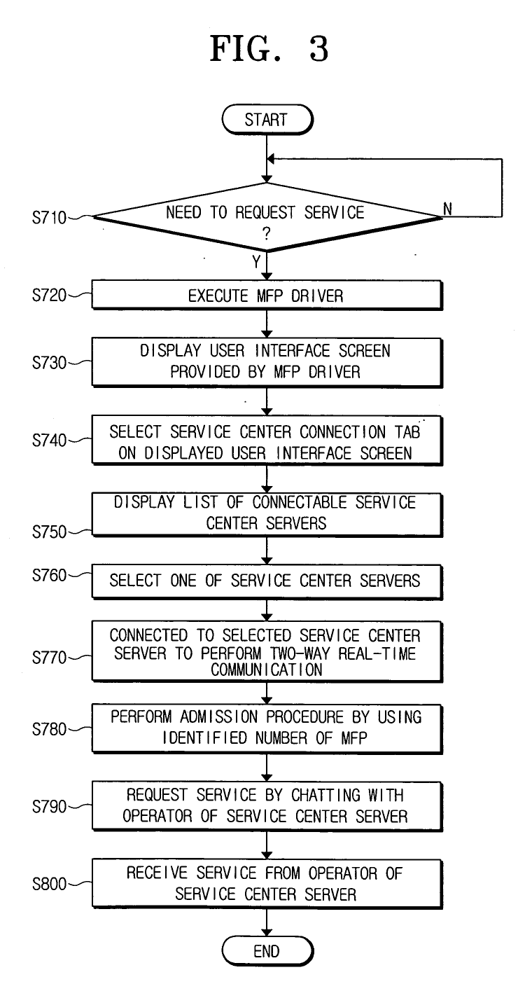

An exemplary process for a user to request service from the service center server 500 by using the PC 300 in the system of FIG. 2 will now be described in greater detail with reference to FIG. 3. FIG. 3 is a flowchart illustrating steps of a method for requesting service by the use of two-way real-time communication with the service center server 500 in accordance with an embodiment of the present invention.

When the user needs to request service for the MFP 100 at step (S710) and the user inputs the execution command of the MFP driver by using the key input unit 350 of the PC 300, the central processing unit 340 executes the MFP driver stored in the storing unit 320 at step (S720).

The service request cases include, for example, (i) an inquiry about specifications of the MFP 100, (ii) an inquiry about usage of the MFP 100, (iii) an inquiry about handling of an operational error of the MFP 100, (iv) a repair request for the MFP 100, (v) an inquiry about supplies (for example, an ink cartridge, a toner cartridge, and the like) for the MFP 100, (vi) a purchase request for supplies for the MFP 100, (vii) an inquiry about driver or firmware updates of the MFP 100, and (viii) a transmission request for a new version MFP driver or firmware.

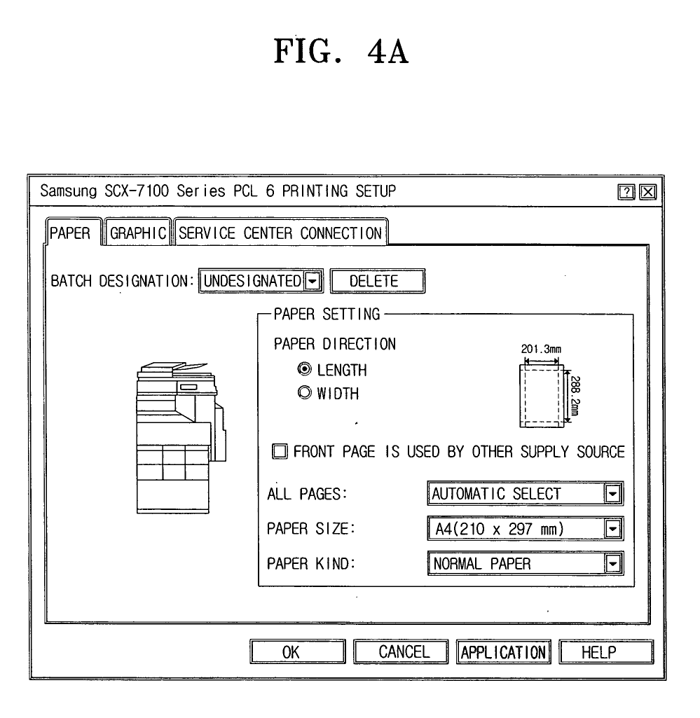

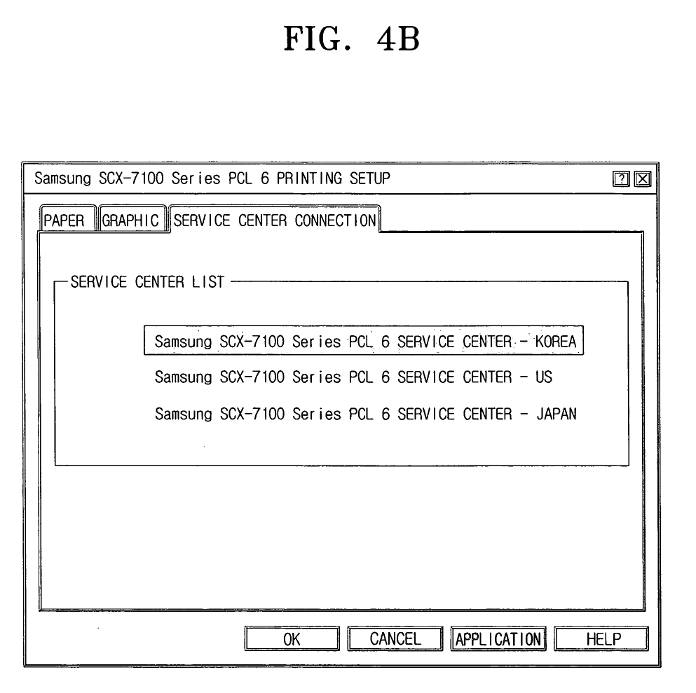

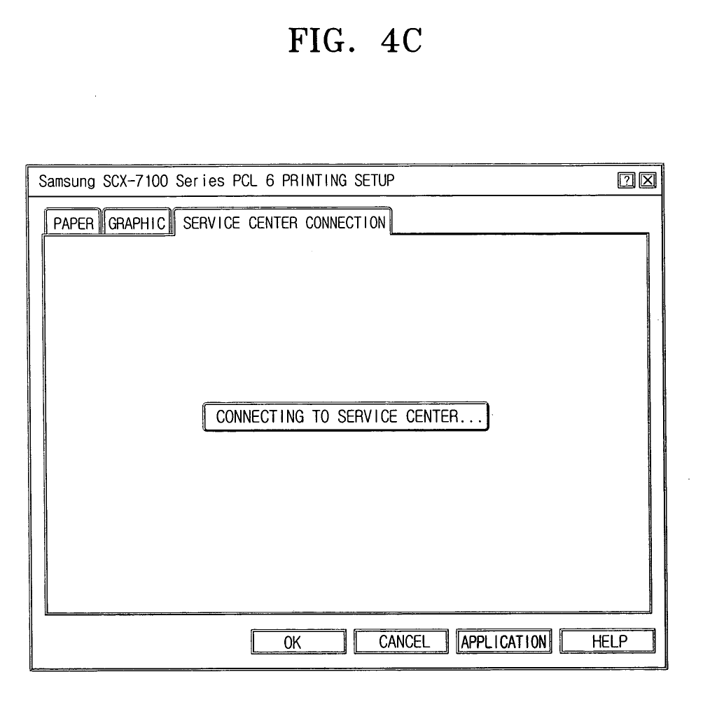

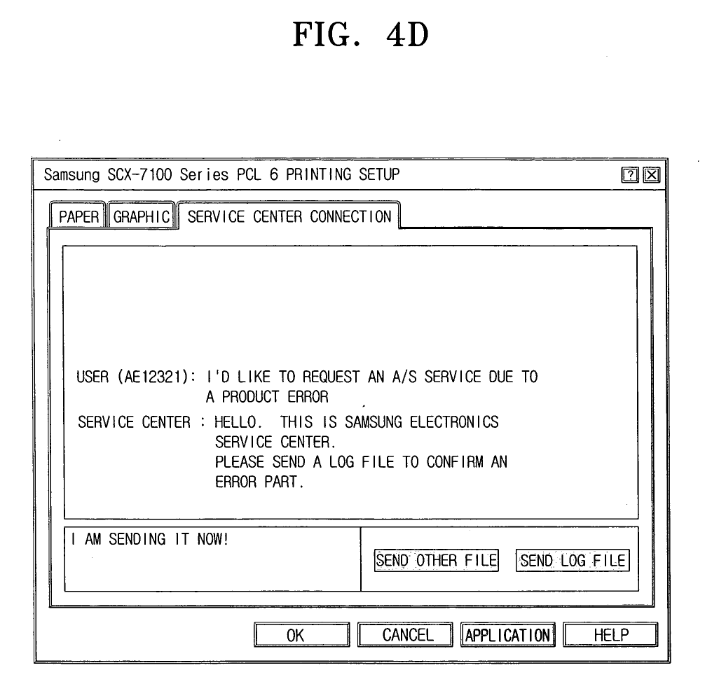

After the central processing unit 340 executes the MFP driver at step (S720), the display unit 330 displays the user interface screen provided by the MFP driver at step (S730). FIG. 4A is an exemplary diagram illustrating a user interface screen provided by the MFP driver, namely, the user interface screen displayed at step (S730). The user interface screen of FIG. 4A is comprised of a tab used to input the connection command of the PC 300 and the service center server 500, namely, a service center connection tab.

In order to request the service from the service center server 500, the user must select the service center connection tab on the user interface screen by using the key input unit 350 at step (S740). When the user selects the service center connection tab, the display unit 330 displays a sub-menu screen relating to the service center connection. The sub-menu screen displays a list of service center, servers that are connectable to the PC 300 at step (S750).

FIG. 4B is an exemplary diagram illustrating a user interface screen showing the list of the service center servers that are connectable to the PC 300. As shown in FIG. 4B, the connectable service center servers may exist in different countries (for example, Korea, the United States, and Japan as shown in FIG. 4B), or may exist in different regions of one country.

Preferably, the list of the service center servers is stored in the storing unit 320. In addition, the PC 300 can update the list of the service center servers stored in the storing unit 320 at a predetermined time interval.

The user can select one of the service center servers displayed at step (S750) by using the key input unit 350 at step (S760). As described above, FIGS. 1 and 2 show only one service center server to simplify the following description. Therefore, it is presumed that the service center server selected by the user at step (S760) is the service center server 500 of FIG. 2.

The internet interface unit 360 is then connected to the service center server 500 selected at step (S760) to perform communication under the control of the central processing unit 340. Specifically, the internet interface unit 360 is connected to the service center server 500 to perform two-way real-time communication at step (S770).

FIG. 4C is an exemplary diagram illustrating the user interface screen displaying a message ‘service center connected’, while the PC 300 and the service center server 500 are connected to each other.

When the PC 300 and the service center server 500 are connected, the PC 300 performs an admission procedure of the service center server 500 by using an identified number of the MFP 100 at step (S780). In detail, the PC 300 transmits the identified number to the service center server 500, and the service center server 500 allows access by the PC 300 when the identified number is valid. That is, the service center server 500 allows access by the purchasers or users of the MFP 100, and prevents access of unspecified individuals to improve operational efficiency.

To achieve this, the PC 300 can store the identified number of the MFP 100 in the storing unit 320. The identified number of the MFP 100 can be comprised of an ID, a serial number, and a model name of the MFP 100.

The admission procedure of step (S780) is not required to be performed by using the identified number of the MFP 100. That is, the admission procedure can also be performed by using an ID and password of the user registered in the service center server 500.

When access by the PC 300 to the service center server 500 is allowed by the admission procedure, the user of the PC 300 can request a desired service by chatting with the operator of the service center server 500 at step (S790). In addition, the user of the PC 300 can request a desired service by visual-chatting with the operator of the service center server 500. This is possible because the PC 300 and the service center server 500 are connected to perform two-way real-time communication.

FIG. 4D is an exemplary diagram illustrating a user interface screen showing chat contents between the user of the PC 300 and the operator of the service center server 500. As depicted in FIG. 4D, the user of the PC 300 can request the service by chatting with the operator of the service center server 500.

In regard to the service request at step (S790), the operator of the service center server 500 can provide the corresponding service to the PC 300. Accordingly, the user can be provided with the service by the operator of the service center server 500 through the PC 300 at step (S800).

In detail, when the service requested at step (S790) is an inquiry about specifications of the MFP 100, an inquiry about usage of the MFP 100, an inquiry about handling of an operational error of the MFP 100, an inquiry about supplies for the MFP 100, or an inquiry about driver or firmware updates of the MFP 100, the service provided at step (S800) is the reply to the inquiry. Especially in a case wherein the inquiry is about toner, or other supplies of the MFP 100, the reply to the inquiry may include type, price, and distributor of the toner in use.

When the service requested at step (S790) is a repair request for the MFP 100 or a purchase request for supplies for the MFP 100, the service provided at step (S800) is the processing result to the request (for example, confirmation of request reception, a visit-repair schedule, a supply delivery schedule, and the like).

When the service requested at step (S790) is a transmission request for a new version MFP driver-or firmware, the service provided at step (S800) is a transmission of the new version MFP driver or firmware.

When the user makes an inquiry about the handling of an operational error of the MFP 100 or a repair request for the MFP 100 at step (S790), the PC 300 can additionally transmit the log file generated in the MFP 100 to the service center server 500. In detail, the user can transmit the log file to the service center server 500 by selecting the ‘send log file’ icon of FIG. 4D by using the key input unit 350. Here, the PC 300 receives the log file stored in the MFP 100, and transmits the received file to the service center server 500.

The operator of the service center server 500 can then analyze the log file. If the MFP 100 can be repaired in a simple manner, the operator of the service center server 500 notifies the user of the error cause and handling method for the MFP 100 by chatting. Therefore, a visit-repair service can be omitted.

In such a manner, the user of the PC 300 can request the service for the MFP 100 from the operator of the service center server 500 by chatting, that is, by connecting the PC 300 and the service center server 500 to perform two-way real-time communication. Here, the PC 300 and the MFP 100 are examples of the user terminal apparatus and the image formation apparatus. However, the present invention can be embodied by different kinds of user terminal apparatuses and image formation apparatuses.

In an exemplary embodiment of the present invention, when the user executes the MFP driver and inputs the connection command of the PC 300 and the service center server 500 by selecting the service center connection tab on the user interface screen provided by the MFP driver, the MFP driver connects the PC 300 and the service center server 500. However, in another embodiment of the present invention, when the user executes the chat program or the chat program included in the MFP driver and inputs the connection command of the PC 300 and the service center server 500 by selecting the tab on the user interface screen provided by the program, the chat program connects the PC 300 and the service center server 500.

In the above embodiment descriptions, several services have been exemplified for better understanding of the present invention. However, the number and types of services that can be requested are not limited to those described above.

As described above, in accordance with an embodiment of the present invention, since the user terminal apparatus and the service center server are connected to perform two-way real-time communication, the user can request and receive the service for the image formation apparatus in real time by chatting with the operator of the service center server.

In addition, the operator of the service center server can analyze the log file generated by the image formation apparatus, and notify the user of the error cause and a handling method for the image formation apparatus by chatting. Therefore, in the case of a simple repair, a visit-repair service can be omitted.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method for requesting a service from a service center server providing services relating to an image formation apparatus by using a terminal apparatus connected to the image formation apparatus, the method comprising the steps of:
(a) inputting a connection command for connecting the terminal apparatus and the service center server;
(b) connecting the terminal apparatus and the service center server to perform two-way communication based on a real time basis when the connection command is input; and
(c) requesting a service from the service center server through the terminal apparatus.

2. The method according to claim 1, wherein step (c) comprises the step of:
performing the service request through at least one of a chat operation and a visual chat operation between a user of the terminal apparatus and an operator of the service center server.

3. The method according to claim 2, wherein, in step (c), the service request comprises at least one of:
an inquiry about specifications of the image formation apparatus, an inquiry about usage of the image formation apparatus, an inquiry about handling of an operational error of the image formation apparatus, a repair request for the image formation apparatus, an inquiry about supplies of the image formation apparatus, a purchase request for supplies of the image formation apparatus, an inquiry about driver updates of the image formation apparatus, an inquiry about firmware updates of the image formation apparatus, a transmission request for a new version driver of the image formation apparatus, and a transmission request for a new version firmware of the image formation apparatus.

4. The method according to claim 3, wherein step (c) further comprises the step of:
transmitting an operation recording file generated in the image formation apparatus to the service center server if the service request is any one of the inquiries about handling of an operational error of the image formation apparatus and repair request for the image formation apparatus.

5. The method according to claim 1, further comprising a step (d) of:
receiving, through the terminal apparatus, a service provided by the operator of the service center server in response to the service request.

6. The method according to claim 1, wherein step (b) comprises the step of:
connecting the terminal apparatus and the service center server to perform two-way communication by using any one of a driver of the image formation apparatus, a chat program, and a chat program included in the driver of the image formation apparatus.

7. The method according to claim 6, wherein at least one of the driver of the image formation apparatus, the chat program, and the chat program included in the driver of the image formation apparatus are installed on the terminal apparatus.

8. The method according to claim 6, wherein step (a) comprises the step of:
inputting the connection command by using a user interface screen provided by any one of the driver of the image formation apparatus, the chat program, and the chat program included in the driver of the image formation apparatus.

9. The method according to claim 8, wherein step (a) comprises the step of:
inputting the connection command by using a sub-menu screen relating to the connection between the terminal apparatus and the service center server displayed on the user interface screen.

10. The method according to claim 1, wherein step (b) comprises the step of:
performing an admission procedure to validate the terminal apparatus by the service center server by using an identified number of the image formation apparatus after the terminal apparatus and the service center server are connected to perform two-way real-time communication.

11. The method according to claim 10, wherein the identified number is comprised of at least one of an ID, a serial number, and a model name of the image formation apparatus.

12. The method according to claim 1, wherein step (b) comprises the step of:
performing an admission procedure to validate the terminal apparatus by the service center server by using at least one of an ID and password of the user registered in the service center server after the terminal apparatus and the service center server are connected to perform the two-way real-time communication.

13. The method according to claim 1, wherein step (a) comprises the sub-steps of:
displaying a list of service center servers when a plurality of service center servers are connectable to the terminal apparatus; and
selecting, through the terminal apparatus, any one of the plurality of service center servers displayed on the list to be connected to the terminal apparatus.

14. The method according to claim 13, wherein the list of service center servers is updated at a predetermined time interval.

15. The method according to claim 13, wherein the plurality of service center servers comprise service center servers located in different countries.

16. A system for requesting a service from a service center server providing services relating to an image formation apparatus, the system comprising:
an image formation apparatus for performing functions of at least one of a copier, printer, fax, and scanner, wherein the image formation apparatus is configured to create an operational log file and transmit the log file to a terminal apparatus; and
a terminal apparatus electrically coupled with the image formation apparatus comprising at least one of a driver of the image formation apparatus, a chat program, and a chat program included in the driver of the image formation apparatus for performing two-way real-time communication between the terminal apparatus and at least one service center server,
wherein the two-way real-time communication provides service requests and service replies between the terminal apparatus and the service center server.

17. A system for requesting a service from a service center server according to claim 16, wherein the image formation apparatus comprises:
a scan unit for generating scan data;
an storing unit comprised of a recording medium for storing the scan data generated by the scan unit, printing data, and the log file;
an interface unit for data communication with the terminal apparatus through a LAN;
a printing unit for printing the scan data or printing data stored in the storing unit on printing paper under the control of a control unit; and
a control unit for controlling the scanning of the scan unit, the communication of the interface unit, the printing of the printing unit, and the creation of the log file, wherein the control unit is configured to transmit the log file stored in the storing unit to the terminal apparatus through the interface unit.

18. A system for requesting a service from a service center server according to claim 16, wherein the terminal apparatus comprises:
a LAN interface unit for performing data communication with the image formation apparatus through a LAN;
a storing unit comprised of a recording medium for storing data and programs used in the terminal apparatus, the driver of the image formation apparatus used for setup and driving control of the image formation apparatus, and the chat program;
a display unit comprised of a display device for displaying a user interface screen provided by the driver of the image formation apparatus;
a key input unit comprised of a user interface device for receiving an operational command from the user, and transmitting the received command to a central processing unit;
an internet interface unit for performing data communication with the service center server through an internet; and
a central processing unit for executing the driver of the image formation apparatus and the chat program stored in the storing unit, controlling the display of the display unit, and controlling the communication between the LAN interface unit and the internet interface unit.
